(19) United States
(12) Patent Application Publication
(10) Pub. No.: US 2026/0120625 A1
(43) Pub. Date: Apr. 30, 2026

(54) DISPLAY DEVICE AND ELECTRONIC APPARATUS INCLUDING THE SAME

(71) Applicant: Samsung Display Co., Ltd., Yongin-si (KR)

(72) Inventor: Hong-Kyu KIM, Yongin-si (KR)

(73) Assignee: Samsung Display Co., Ltd., Yongin-si (KR)

(21) Appl. No.: 19/283,963

(22) Filed: Jul. 29, 2025

(30) Foreign Application Priority Data
Oct. 31, 2024 (KR) 10-2024-0152072

(51) Int. Cl. G09G 3/32

(52) U.S. Cl. CPC G09G 3/32; G09G 2300/0842; G09G 2310/0267; G09G 2310/08; G09G 2320/0247; G09G 2330/021; G09G 2340/0435

(57) ABSTRACT

A display device includes a display panel including a pixel, a scan driver configured to provide a first scan signal and a second scan signal to the pixel, and a power management circuit configured to provide a first power voltage and a second power voltage to the pixel. The second scan signal includes an active pulse in an active period having a constant time length and a plurality of dummy pulses in a vertical blank period having a variable time length. Widths of the plurality of dummy pulses are less than a width of the active pulse. Intervals between the plurality of dummy pulses are less than an interval between the active pulse and a first dummy pulse of the plurality of dummy pulses.

### CROSS-REFERENCE TO RELATED APPLICATION(S)

This application claims priority under 35 USC § 119 to Korean Patent Application No. 10-2024-0152072 filed on Oct. 31, 2024, in the Korean Intellectual Property Office (KIPO), the entire disclosure of which is incorporated by reference herein.

### BACKGROUND

### 1. Field

Example embodiments relate to a display device. More particularly, example embodiments relate to a display device driven by a variable refresh rate and/or an electronic apparatus including the display device.

### 2. Description of the Related Art

A display device may include a display panel, a scan driver, and a power management circuit. The display panel may include pixels for displaying an image. The scan driver may provide scan signals to the pixels. The power management circuit may provide power voltages to the pixels.

The display device may be driven in a variable refresh rate (VRR) mode in which a driving frequency of the display panel may change. When the display device displays a moving image, the driving frequency of the display panel may increase to relatively improve an image quality of the display device. When the display device displays a still image, the driving frequency of the display panel may decrease to reduce a power consumption of the display device.

### SUMMARY

Some example embodiments provide a display device with an improved image quality and an electronic apparatus including the display device.

A display device according to some example embodiments includes a display panel including a pixel, a scan driver configured to provide a first scan signal and a second scan signal to the pixel, and a power management circuit configured to provide a first power voltage and a second power voltage to the pixel, wherein the second scan signal includes an active pulse in an active period having a constant time length and a plurality of dummy pulses in a vertical blank period having a variable time length, wherein widths of the plurality of dummy pulses are less than a width of the active pulse, and wherein intervals between the plurality of dummy pulses are less than an interval between the active pulse and a first dummy pulse of the plurality of dummy pulses.

In some example embodiments, the widths of the plurality of dummy pulses may be equal to each other.

In some example embodiments, the intervals between the plurality of dummy pulses may be equal to each other.

In some example embodiments, the pixel may include a first transistor including a first gate connected to a first node, a first terminal configured to receive the first power voltage, and a second terminal connected to a second node, a second transistor including a second gate configured to receive the first scan signal, a third terminal configured to receive a data voltage, and a fourth terminal connected to the first node, a third transistor including a third gate configured to receive the second scan signal, a fifth terminal configured to receive a reference voltage, and a sixth terminal connected to the second node, a capacitor including a seventh terminal connected to the first node and an eighth terminal connected to the second node, and a light-emitting diode including a ninth terminal connected to the second node and a tenth terminal configured to receive the second power voltage.

In some example embodiments, the capacitor may be configured to store a difference between the data voltage and the reference voltage in response to a pulse of the first scan signal and the active pulse of the second scan signal in the active period, and wherein the third transistor may be configured to apply the reference voltage to the second node in response to the plurality of dummy pulses.

In some example embodiments, a voltage level of the reference voltage may be lower than a voltage level of a threshold voltage of the light-emitting diode.

In some example embodiments, the first scan signal may include a pulse in the active period, and a deactivation level in the vertical blank period.

In some example embodiments, the first power voltage may have a constant high voltage level and the second power voltage may have a constant low voltage level lower than the constant high voltage level.

A display device according to some example embodiments includes a display panel including a pixel, a scan driver configured to provide a first scan signal and a second scan signal to the pixel, and a power management circuit configured to provide a power voltage to the pixel, wherein the second scan signal includes an active pulse in an active period having a constant time length, the power voltage includes a plurality of pulses in a vertical blank period having a variable time length, widths of the plurality of pulses of the power voltage are less than a width of the active pulse, and intervals between the plurality of pulses of the power voltage are less than an interval between the active pulse and a first pulse of the plurality of pulses of the power voltage.

In some example embodiments, the widths of the plurality of pulses of the power voltage may be equal to each other.

In some example embodiments, the intervals between the plurality of pulses of the power voltage may be equal to each other.

In some example embodiments, the pixel may include a first transistor including a first gate connected to a first node, a first terminal configured to receive a first power voltage, and a second terminal connected to a second node, a second transistor including a second gate configured to receive the first scan signal, a third terminal configured to receive a data voltage, and a fourth terminal connected to the first node, a third transistor including a third gate configured to receive the second scan signal, a fifth terminal configured to receive a reference voltage, and a sixth terminal connected to the second node, a capacitor including a seventh terminal connected to the first node and an eighth terminal connected to the second node, and a light-emitting diode including a ninth terminal connected to the second node and a tenth terminal configured to receive a second power voltage, wherein the power voltage may be the first power voltage or the second power voltage.

In some example embodiments, the power voltage may be the first power voltage, and may have a constant high voltage level in the active period, and the plurality of pulses of the power voltage may have a low voltage level lower than the constant high voltage level.

In some example embodiments, the power voltage may be the second power voltage, and may have a constant low voltage level in the active period, and the plurality of pulses of the power voltage may have a high voltage level higher than the constant low voltage level.

In some example embodiments, the first scan signal may include a pulse in the active period, and a deactivation level in the vertical blank period.

In some example embodiments, the second scan signal may have a deactivation level in the vertical blank period.

An electronic apparatus according to some example embodiments includes a display device, and a processor configured to control the display device, wherein the display device includes a display panel including a pixel, a scan driver configured to provide a first scan signal and a second scan signal to the pixel, and a power management circuit configured to provide a first power voltage and a second power voltage to the pixel, wherein the second scan signal includes an active pulse in an active period having a constant time length and a plurality of dummy pulses in a vertical blank period having a variable time length, widths of the plurality of dummy pulses are less than a width of the active pulse, and intervals between the plurality of dummy pulses are less than an interval between the active pulse and a first dummy pulse of the plurality of dummy pulses.

In some example embodiments, the widths of the plurality of dummy pulses may be equal to each other.

In some example embodiments, the intervals between the plurality of dummy pulses may be equal to each other.

In some example embodiments, the pixel may include a first transistor including a first gate connected to a first node, a first terminal configured to receive the first power voltage, and a second terminal connected to a second node, a second transistor including a second gate configured to receive the first scan signal, a third terminal configured to receive a data voltage, and a fourth terminal connected to the first node, a third transistor including a third gate configured to receive the second scan signal, a fifth terminal configured to receive a reference voltage, and a sixth terminal connected to the second node, a capacitor including a seventh terminal connected to the first node and an eighth terminal connected to the second node, and a light-emitting diode including a ninth terminal connected to the second node and a tenth terminal configured to receive the second power voltage.

In the display device and the electronic apparatus according to some example embodiments, i) the width of the dummy pulse of the second scan signal is less than the width of the active pulse of the second scan signal, and the intervals between the dummy pulses of the second scan signal is less than the interval between the active pulse and the first dummy pulse of the second scan signal, or ii) the width of the pulse of the power voltage is less than the width of the active pulse of the second scan signal, and the intervals between the pulses of the power voltage is less than the interval between the active pulse of the second scan signal and the first pulse of the power voltage, so that a luminance deviation between frequencies may decrease, and accordingly, the image quality of the display device may be improved.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display device according to an some example embodiments.

FIG. 2 is a circuit diagram illustrating a pixel of FIG. 1.

FIG. 3 is a diagram for describing a variable refresh rate mode of the display device of FIG. 1.

FIG. 4 is a timing diagram for describing an operation of a pixel at first and second frequencies according to a comparative example.

FIG. 5 is a timing diagram illustrating a luminance of a display device at first and second frequencies according to a comparative example.

FIG. 6 is a diagram for describing an operation of a pixel at a second frequency when a dummy off driving is used.

FIG. 7 is a timing diagram illustrating a luminance of a display device at a second frequency when the dummy off driving is used.

FIG. 8 is a graph illustrating a relationship between a frequency and a luminance of a display device when the dummy off driving is used and when the dummy off driving is not used.

FIG. 9 is a diagram illustrating off numbers and luminances of a light-emitting diode at first to fifth frequencies when the dummy off driving is used.

FIG. 10 is a timing diagram illustrating a first scan signal, a second scan signal, a first power voltage, a second power voltage, and a luminance according to some example embodiments.

FIG. 11 is a graph illustrating a relationship between a frequency and a luminance of a display device when the dummy off driving is used and when a split dummy off driving is used.

FIG. 12 is a diagram illustrating a luminance of a display device at the same frequency when the dummy off driving is used and when the split dummy off driving is used.

FIG. 13 is a timing diagram illustrating a first scan signal, a second scan signal, a first power voltage, a second power voltage, and a luminance according to some example embodiments.

FIG. 14 is a timing diagram illustrating a first scan signal, a second scan signal, a first power voltage, a second power voltage, and a luminance according to some example embodiments.

FIG. 15 is a block diagram illustrating an electronic apparatus according to some example embodiments.

FIG. 16 is a diagram illustrating an example in which the electronic apparatus of FIG. 15 is implemented as a computer monitor.

### DETAILED DESCRIPTION

Hereinafter, a display device and an electronic apparatus according to some example embodiments will be described in more detail with reference to the accompanying drawings. The same or similar reference numerals will be used for the same elements in the accompanying drawings.

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same.

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%. Further, regardless of whether numerical values or shapes are modified as “about” or “substantially,” it will be understood that these values and shapes should be construed as including a manufacturing or operational tolerance (e.g., ±10%) around the stated numerical values or shapes.

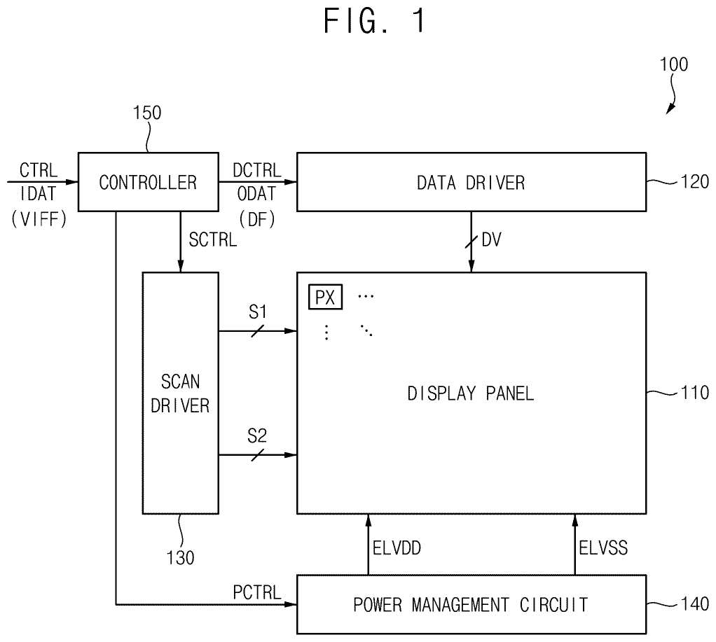

FIG. 1 is a block diagram illustrating a display device 100 according to some example embodiments.

Referring to FIG. 1, the display device 100 may include a display panel 110, a data driver 120, a scan driver 130, a power management circuit 140, and/or a controller 150.

The display panel 110 may include a plurality of data lines, a plurality of first scan lines, a plurality of second scan lines, and/or a plurality of pixels PX. The data lines may provide data voltages DV to the pixels PX. The first scan lines may provide first scan signals S1 to the pixels PX. The second scan lines may provide second scan signals S2 to the pixels PX. The pixels PX may emit light in response to the data voltages DV, the first scan signals S1, and/or the second scan signals S2.

The display panel 110 may further include a plurality of reference voltage lines. The reference voltage lines may provide reference voltages to the pixels PX. In some example embodiments, the reference voltage lines may be used as sensing lines for sensing characteristics of the pixels PX.

The data driver 120 may provide the data voltages DV to the pixels PX through the data lines. The data driver 120 may generate the data voltages DV based on a data control signal DCTRL and output image data ODAT. In some example embodiments, the data control signal DCTRL may include an output data enable signal, a horizontal start signal, and/or a load signal. In some example embodiments, the data driver 120 may receive the output image data ODAT at a driving frequency DF that is variable within a selected range.

In some example embodiments, the data driver 120 and the controller 150 may be implemented as a single integrated circuit, and such an integrated circuit may be called a timing controller embedded data driver (TED). In some example embodiments, the data driver 120 and the controller 150 may be implemented as separate integrated circuits.

The scan driver 130 may sequentially provide the first scan signals S1 to the pixels PX through the first scan lines on a pixel row basis, and may sequentially provide the second scan signals S2 to the pixels PX through the second scan lines on a pixel row basis. The scan driver 130 may generate the first scan signals S1 and/or the second scan signals S2 based on a scan control signal SCTRL.

In some example embodiments, the scan driver 130 may be formed and/or mounted in a peripheral area of the display panel 110. In some example embodiments, the scan driver 130 may be implemented as at least one integrated circuit.

The power management circuit 140 may provide a first power voltage ELVDD and/or a second power voltage ELVSS to the pixels PX. The power management circuit 140 may generate the first power voltage ELVDD and/or the second power voltage ELVSS based on a power control signal PCTRL.

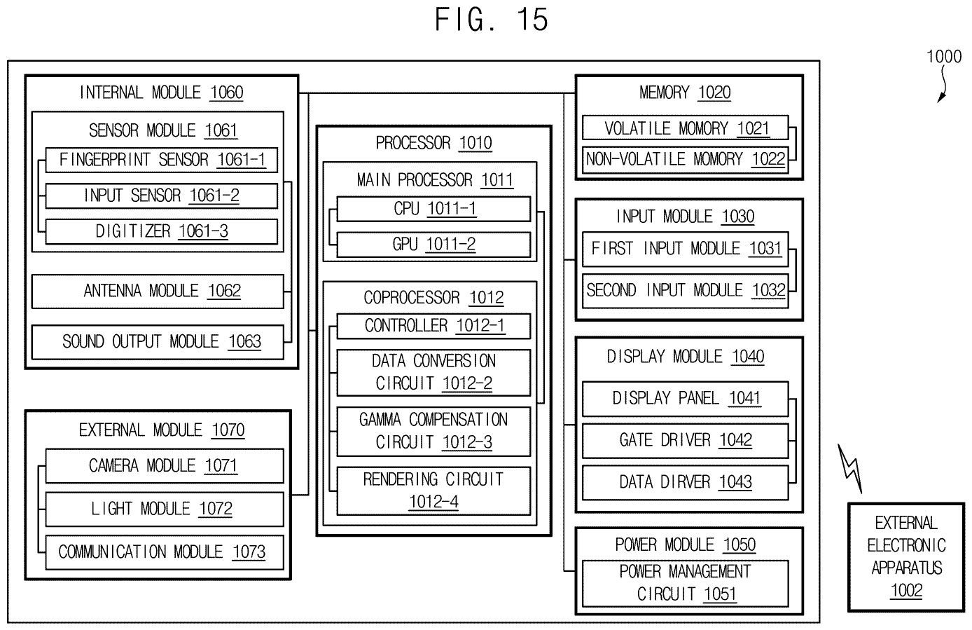

The controller 150 may control an operation (or driving) of the data driver 120, an operation (or driving) of the scan driver 130, and/or an operation (or driving) of the power management circuit 140. The controller 150 may provide the output image data ODAT and the data control signal DCTRL to the data driver 120, may provide the scan control signal SCTRL to the scan driver 130, and may provide the power control signal PCTRL to the power management circuit 140. The controller 150 may generate the output image data ODAT, the data control signal DCTRL, the scan control signal SCTRL, and/or the power control signal PCTRL based on input image data IDAT and/or a control signal CTRL. In some example embodiments, the input image data IDAT may include red image data, green image data, and/or blue image data. In some example embodiments, the control signal CTRL may include a vertical synchronization signal, a horizontal synchronization signal, an input data enable signal, and/or a master clock signal. The controller 150 may receive the input image data IDAT and/or the control signal CTRL from an external host processor (e.g., processor 1010 shown in FIG. 15).

The host processor may change a time length of a vertical blank period for each, or one or more, frame period to provide the input image data IDAT to the controller 150 at a variable input frame frequency VIFF (or variable frame rate) that varies within a selected range. The controller 150 may control the data driver 120, the scan driver 130, and/or the power management circuit 140 to drive the display panel 110 at the driving frequency DF corresponding to the variable input frame frequency VIFF. For example, the driving frequency DF of the display panel 110 may be determined as the variable input frame frequency VIFF. In some example embodiments, a mode of the display device 100 that drives the display panel 110 at the variable input frame frequency VIFF may be called a variable refresh rate (VRR) mode. The variable refresh rate mode may be a free-sync mode, a G-sync mode, etc., but is not limited thereto.

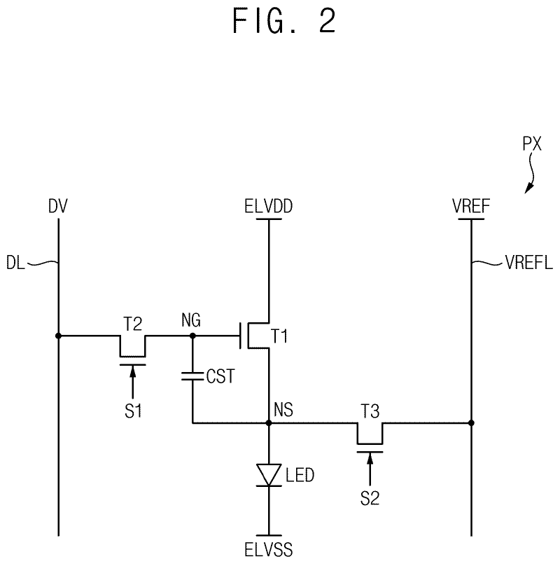

FIG. 2 is a circuit diagram illustrating the pixel PX of FIG. 1.

Referring to FIGS. 1 and 2, the pixel PX may include a first transistor T1, a second transistor T2, a third transistor T3, a capacitor CST, and/or a light-emitting diode LED. The pixel PX may receive a first scan signal S1, a second scan signal S2, a data voltage DV, a reference voltage VREF, a first power voltage ELVDD, and/or a second power voltage ELVSS. In some example embodiments, a voltage level of the first power voltage ELVDD may be higher than a voltage level of the second power voltage ELVSS. In some example embodiments, a voltage level of the reference voltage VREF may be lower than a voltage level of a threshold voltage of the light-emitting diode LED.

The first transistor T1 may generate a driving current corresponding to a voltage difference between a first node NG and a second node NS. The first transistor T1 may include a gate connected to the first node NG, a first terminal (e.g., a drain) that receives the first power voltage ELVDD, and/or a second terminal (e.g., a source) connected to the second node NS.

The second transistor T2 may transmit the data voltage DV to the first node NG in response to the first scan signal S1. The second transistor T2 may include a gate that receives the first scan signal S1, a first terminal (e.g., a drain) connected to a data line DL that transmits the data voltage DV, and/or a second terminal (e.g., a source) connected to the first node NG.

The third transistor T3 may transmit the reference voltage VREF to the second node NS in response to the second scan signal S2. The third transistor T3 may include a gate that receives the second scan signal S2, a first terminal (e.g., a drain) connected to a reference voltage line VREFL that transmits the reference voltage VREF, and/or a second terminal (e.g., a source) connected to the second node NS. In some example embodiments, the third transistor T3 may transmit a voltage of the second node NS that reflects characteristics of the first transistor T1 and/or characteristics of the light-emitting diode LED to the reference voltage line VREFL in response to the second scan signal S2.

In some example embodiments, each, or one or more, of the first transistor T1, the second transistor T2, and/or the third transistor T3 may be an NMOS transistor. In some example embodiments, at least one of the first transistor T1, the second transistor T2, and/or the third transistor T3 may be a PMOS transistor.

The capacitor CST may be connected between the first node NG and the second node NS. The capacitor CST may include a first terminal connected to the first node NG and/or a second terminal connected to the second node NS.

The light-emitting diode LED may include a first terminal (e.g., an anode) connected to the second node NS and/or a second terminal (e.g., a cathode) that receives the second power voltage ELVSS. The light-emitting diode LED may emit light with a luminance corresponding to the driving current generated by the first transistor T1.

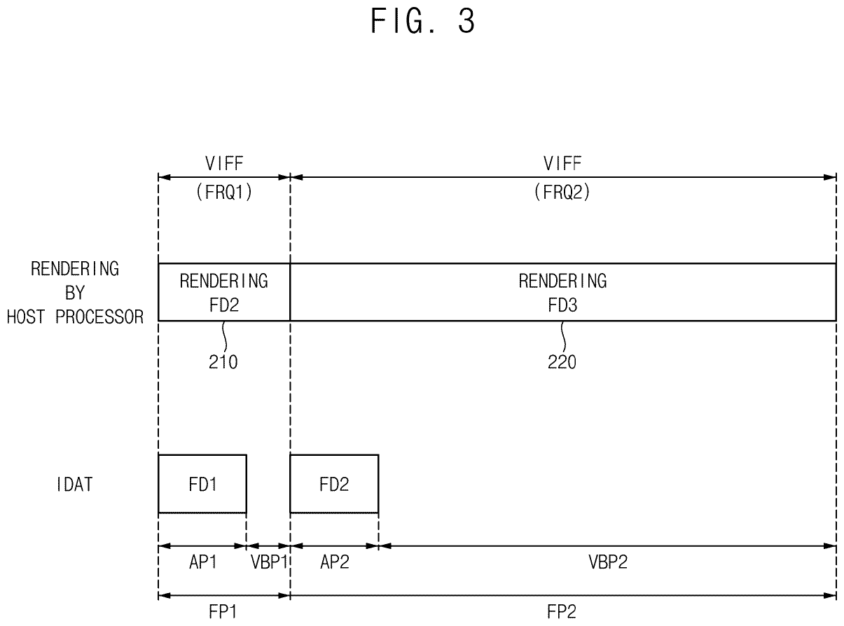

FIG. 3 is a diagram for describing the variable refresh rate mode of the display device 100 of FIG. 1.

Referring to FIGS. 1 and 3, a cycle or frequency of rendering 210 and 220 of the host processor may not be constant, and the host processor may provide the input image data IDAT (e.g., frame data FD1 and/or FD2) to the display device 100 in synchronization with the non-constant cycle or frequency of the rendering 210 and 220 in the variable refresh rate mode. In the variable refresh rate mode, each, or one or more, frame period FP1 and/or FP2 may have an active period AP1 and/or AP2 having a constant time length, and the host processor may provide the frame data FD1 and/or FD2 to the display device 100 with the variable input frame frequency VIFF by changing a time length of a vertical blank period VBP1 and/or VBP2 of each, or one or more, frame period FP1 and/or FP2.

As illustrated in FIG. 3, in the first frame period FP1, when the second frame data FD2 is rendered 210 at a first frequency FRQ1, the host processor may provide the first frame data FD1 to the display device 100 at the variable input frame frequency VIFF of the first frequency FRQ1. Further, the host processor may output the second frame data FD2 during the active period AP2 of the second frame period FP2, and may continue the vertical blank period VBP2 of the second frame period FP2 until the rendering 220 for the third frame data FD3 is completed. Accordingly, in the second frame period FP2, when the third frame data FD3 is rendered 220 at a second frequency FRQ2 lower than the first frequency FRQ1, the host processor may increase the time length of the vertical blank period VBP2 of the second frame period FP2 to provide the second frame data FD2 at the variable input frame frequency VIFF of the second frequency FRQ2 to the display device 100.

In the variable refresh rate mode, each, or one or more, frame period FP1 and FP2 may include the active period AP1 and/or AP2 having a constant time length regardless of the variable input frame frequency VIFF, and the vertical blank periods VBP1 and/or VBP2 having a variable time length corresponding to the variable input frame frequency VIFF. For example, in the variable refresh rate mode, as the variable input frame frequency VIFF decreases, the time length of the vertical blank period VBP1 and/or VBP2 may increase. In the variable refresh rate mode, the controller 150 may output the input image data IDAT received at the variable input frame frequency VIFF as the output image data ODAT at the driving frequency DF substantially equal to the variable input frame frequency VIFF to the data driver 120. Accordingly, the display device 100 supporting the variable refresh rate mode may display an image in synchronization with the variable input frame frequency VIFF to reduce or prevent a tearing phenomenon caused by frame frequency mismatch.

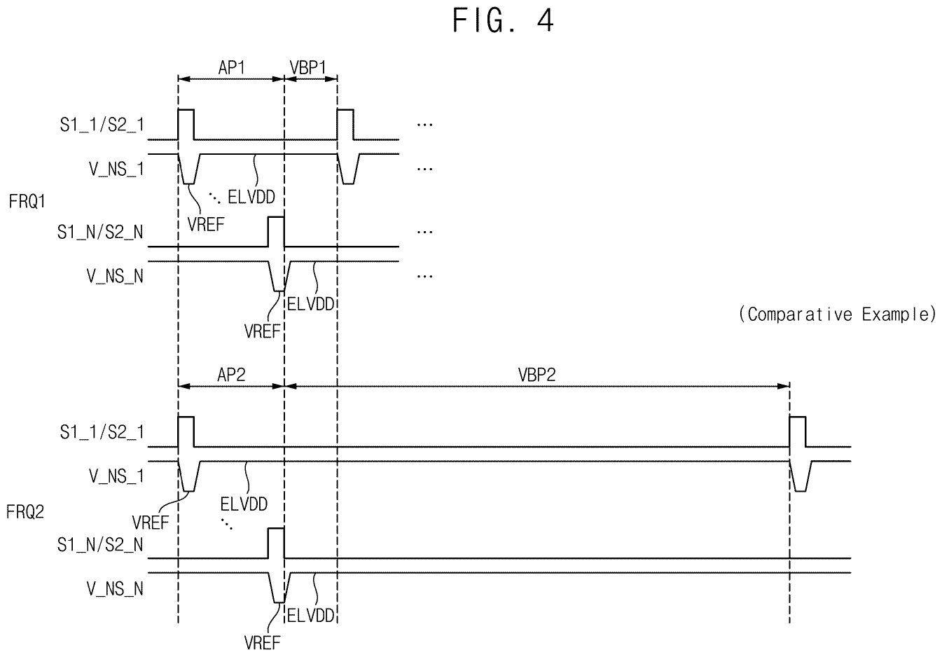

FIG. 4 is a timing diagram for describing an operation of a pixel PX at first and second frequencies FRQ1 and FRQ2 according to a comparative example.

Referring to FIGS. 2 and 4, the pixel PX may simultaneously receive pulses of the first and second scan signals S1 and S2 in each, or one or more, active period AP1 and/or AP2. When the pulses of the first and second scan signals S1 and S2 are applied to the pixel PX, the data voltage DV may be applied to the first node NG (e.g., the first terminal of the capacitor CST) and the reference voltage VREF may be applied to the second node NS (e.g., the second terminal of the capacitor CST). Accordingly, when the pulses of the first and second scan signals S1 and S2 are applied to the pixel PX, the capacitor CST may store a difference between the data voltage DV and the reference voltage VREF. When the pulses of the first and second scan signals S1 and S2 are applied to the pixel PX, the light-emitting diode LED may not emit light because the second node NS connected to the first terminal of the light-emitting diode LED has the reference voltage VREF.

The time length of the vertical blank periods VBP1 and/or VBP2 may change depending on the driving frequency DF of the display panel 110. The time length of the vertical blank period VBP1 when the display panel 110 is driven at a first frequency FRQ1 may be different from the time length of the vertical blank period VBP2 when the display panel 110 is driven at a second frequency FRQ2 different from the first frequency FRQ1. During the same time length, the number of times the pulses of the first and second scan signals S1 and S2 are applied to the pixel PX when the display panel 110 is driven at the first frequency FRQ1 (e.g., the number of times the light-emitting diode LED is turned off) may be different from the number of times the pulses of the first and second scan signals S1 and S2 are applied to the pixel PX when the display panel 110 is driven at the second frequency FRQ2. Accordingly, even if the display device according to the comparative example displays an image with the same grayscale, when the driving frequency DF of the display panel 110 changes, a luminance of the display panel 110 may change, and flicker may occur.

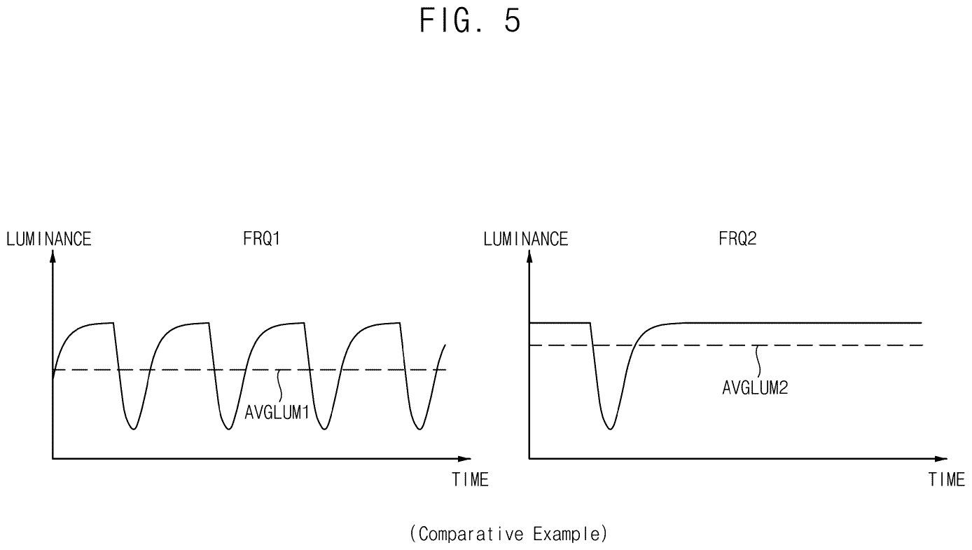

FIG. 5 is a timing diagram illustrating a luminance of a display device at the first and second frequencies FRQ1 and FRQ2 according to the comparative example.

Referring to FIG. 5, in the display device according to the comparative example, during the same time length, the light-emitting diode LED of the display panel 110 driven at the first frequency FRQ1 (e.g., about 240 Hz) may be turned off about 4 times, and the light-emitting diode LED of the display panel 110 driven at the second frequency FRQ2 (e.g., about 60 Hz) may be turned off about once. Accordingly, an average luminance AVGLUM2 (e.g., 2.1 nits) of the display panel 110 driven at the second frequency FRQ2 may be higher than an average luminance AVGLUM1 (e.g., 1.6 nits) of the display panel 110 driven at the first frequency FRQ1.

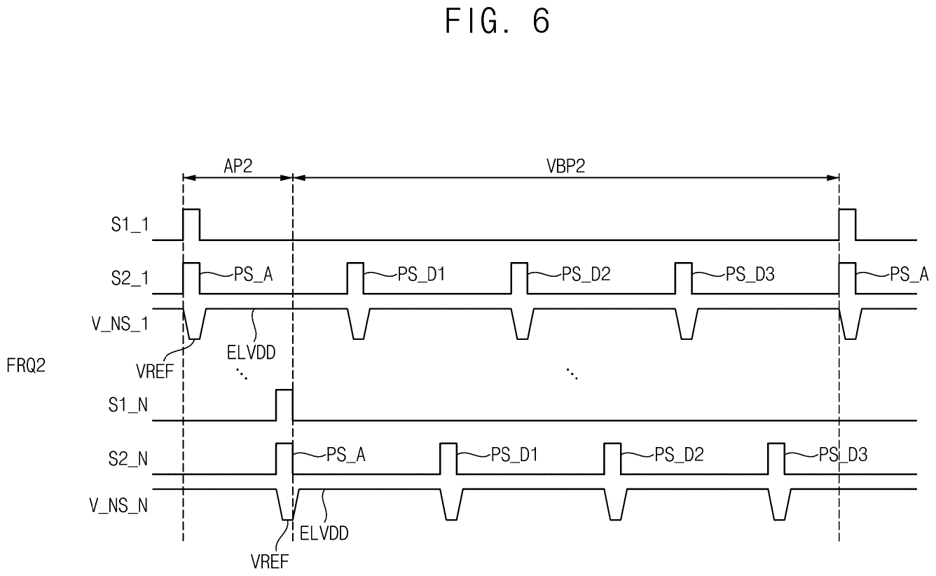

FIG. 6 is a diagram for describing an operation of a pixel PX in the second frequency FRQ2 when a dummy off driving is used.

Referring to FIGS. 2 and 6, in order to reduce or prevent the luminance increase of the display panel 110 at a low frequency, the first scan signal S1 may be provided to the pixel PX at the driving frequency DF, and the second scan signal S2 may be provided to the pixel PX at a maximum driving frequency (e.g., the first frequency FRQ1). A driving mode in which the second scan signal S2 is provided to the pixel PX at the maximum driving frequency may be called the dummy off driving.

As illustrated in FIG. 6, when the display panel 110 is driven at the second frequency FRQ2 lower than the first frequency FRQ1 that is the maximum driving frequency, pulses of the first scan signals S1_1, . . . , S1_N and active pulses PS_A of the second scan signals S2_1, . . . , S2_N may be sequentially provided to the pixels PX on a pixel row basis in the active period AP2, pulses of the first scan signals S1_1,. . . . , S1_N may not be provided to the pixels PX in the vertical blank period VBP2, and dummy pulses PS_D1, PS_D2, and PS_D3 of the second scan signals S2_1, . . . , S2_N may be sequentially provided to the pixels PX on a pixel row basis at least once in the vertical blank period VBP2. For example, as illustrated in FIG. 6, when the display panel 110 is driven at the second frequency FRQ2, the dummy pulses PS_D1, PS_D2, and PS_D3 of the second scan signals S2_1, . . . , S2_N may be provided three times to the pixels PX in the vertical blank period VBP2. Accordingly, while the pulses of the first scan signals S1_1, . . . , S1_N are not applied to the pixel PX and the dummy pulses PS_D1, PS_D2, and PS_D3 of the second scan signals S2_1, . . . , S2_N are applied to the pixel PX in the vertical blank period VBP2, the third transistor T3 of the pixel PX may apply the reference voltage VREF to the second node NS, and the voltage V_NS_1, . . . , V_NS_N of the second node NS may change from the first power voltage ELVDD to the reference voltage VREF. The light-emitting diode LED of the pixel PX may not emit light due to the voltage V_NS_1, . . . , V_NS_N of the second node NS having the reference voltage VREF. Accordingly, the light-emitting diode LED may not emit light while the pulse of the first scan signal S1_1, . . . , S1_N and the active pulse PS_A of the second scan signal S2_1, . . . , S2_N are applied to the pixel PX in the active period AP2, and the light-emitting diode LED may not emit light while only the dummy pulses PS_D1, PS_D2, and PS_D3 of the second scan signal S2_1, . . . , S2_N are applied to the pixel PX.

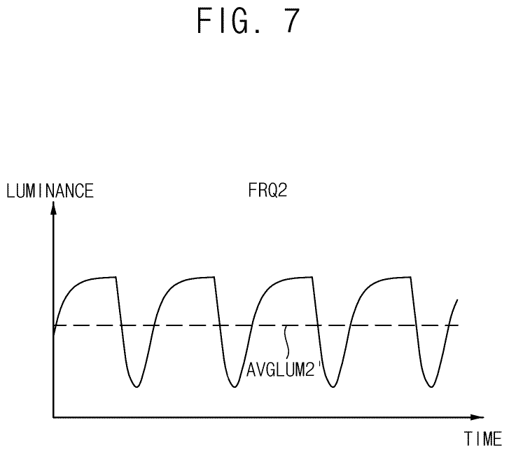

FIG. 7 is a timing diagram illustrating a luminance of a display device in the second frequency FRQ2 when the dummy off driving is used.

Referring to FIGS. 5 and 7, when the dummy off driving is used, the number of times the light-emitting diode LED of the pixel PX is turned off when the display panel 110 is driven at the first frequency FRQ1 may be substantially the same as the number of times the light-emitting diode LED of the pixel PX is turned off when the display panel 110 is driven at the second frequency FRQ2. Accordingly, when the dummy off driving is used, even if the driving frequency DF of the display panel 110 changes, the luminance of the display panel 110 may not substantially change, and the flicker may not occur. As illustrated in FIGS. 5 and 7, when the dummy off driving is used, during the same time length, the light-emitting diode LED of the display panel 110 driven at the first frequency FRQ1 may be turned off about 4 times, and the light-emitting diode LED of the display panel 110 driven at the second frequency FRQ2 may also be turned off about 4 times. Accordingly, an average luminance AVGLUM2′ (e.g., 1.6 nits) of the display panel 110 driven at the second frequency FRQ2 may be substantially equal to the average luminance AVGLUM1 (e.g., 1.6 nits) of the display panel 110 driven at the first frequency FRQ1.

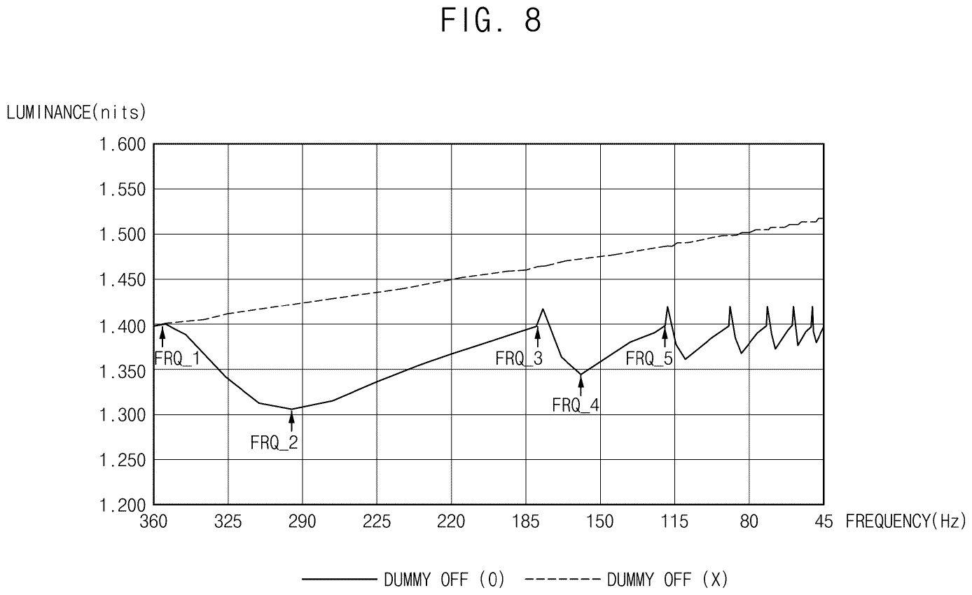

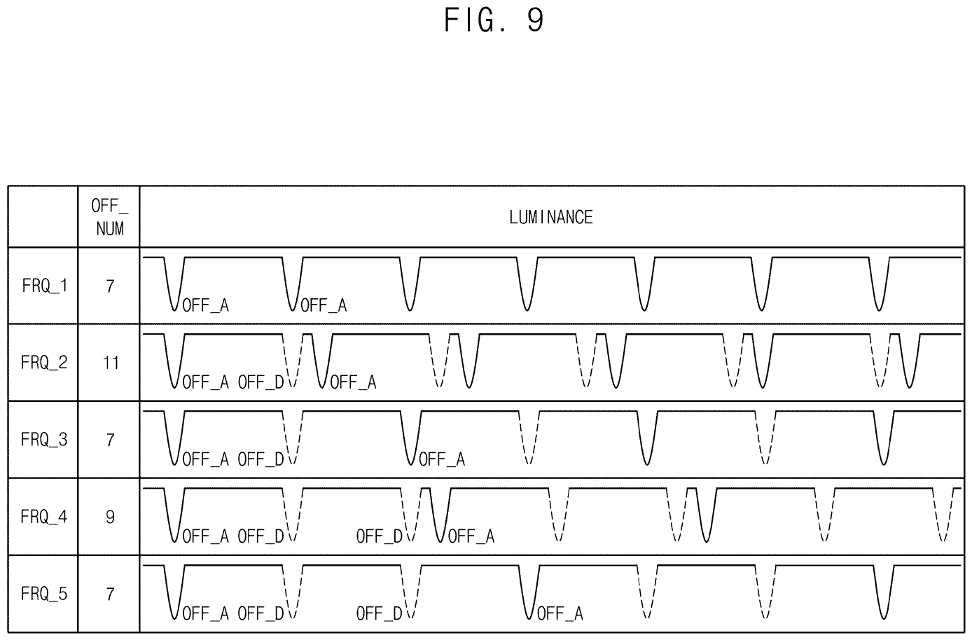

FIG. 8 is a graph illustrating a relationship between a frequency and a luminance of the display device when the dummy off driving is used and when the dummy off driving is not used. FIG. 9 is a diagram illustrating number of off-times OFF_NUM and luminances of a light-emitting diode at first to fifth frequencies FRQ_1, FRQ_2, FRQ_3, FRQ_4, and FRQ_5 when the dummy off driving is used.

Referring to FIGS. 8 and 9, when the display device does not use the dummy off driving, the luminance of the display device may increase as the frequency of the display device decreases. An interval between active-offs OFF_A of the light-emitting diode (e.g., off-periods of the light-emitting diode in the active period) may increase as the frequency of the display device decreases, and accordingly, during the same time length, the number of active-offs of the light-emitting diode may decrease as the frequency of the display device decreases. For example, during the same time length, the number of active-offs OFF_A of the light-emitting diode at the first frequency FRQ_1 may be 7, the number of active-offs OFF_A of the light-emitting diode at the second frequency FRQ_2 may be 6, the number of active-offs OFF_A of the light-emitting diode at the third frequency FRQ_3 may be 4, the number of active-offs OFF_A of the light-emitting diode at the fourth frequency FRQ_4 may be 3, and/or the number of active-offs OFF_A of the light-emitting diode at the fifth frequency FRQ_5 may be 3.

When the display device uses the dummy off driving, the luminance of the display device may be reduced or prevented from increasing at a low frequency. Even though the interval between the active-offs OFF_A of the light-emitting diode increases as the frequency of the display device decreases, since dummy-offs OFF_D of the light-emitting diode (e.g., an off-period of the light-emitting diode in the vertical blank period) are periodically inserted after the active-off OFF_A of the light-emitting diode, the number of off-times OFF_NUM of the light-emitting diode, which is the sum of the number of active off-times and the number of dummy off-times of the light-emitting diode, may increase at the low frequency.

When the display device uses the dummy off driving, the number of off-times OFF_NUM of the light-emitting diode for the same time length may vary depending on the frequency of the display device, and a deviation in the number of off-times of the light-emitting diode between frequencies may increase. For example, during the same time length, the number of off-times OFF_NUM of the light-emitting diode at the first frequency FRQ_1 may be 7, the number of off-times OFF_NUM of the light-emitting diode at the second frequency FRQ_2 may be 11, the number of off-times OFF_NUM of the light-emitting diode at the third frequency FRQ_3 may be 7, the number of off-times OFF_NUM of the light-emitting diode at a fourth frequency FRQ_4 may be 9, and/or the number of off-times OFF_NUM of the light-emitting diode at the fifth frequency FRQ_5 may be 7. Accordingly, a luminance deviation between the frequencies may increase, and an image quality of the display device may deteriorate.

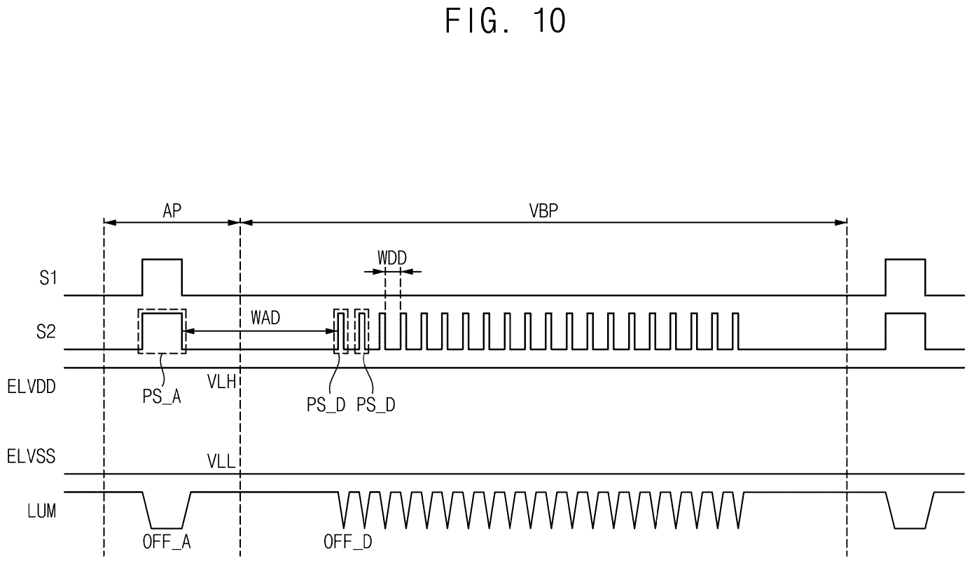

FIG. 10 is a timing diagram illustrating a first scan signal S1, a second scan signal S2, a first power voltage ELVDD, a second power voltage ELVSS, and a luminance LUM according to some example embodiments.

Referring to FIG. 10, the second scan signal S2 may include an active pulse PS_A in the active period AP and a plurality of dummy pulses PS_D in the vertical blank period VBP. In some example embodiments, in order to reduce a luminance deviation between frequencies, widths of the dummy pulses PS_D of the second scan signal S2 may be less than a width of the active pulse PS_A of the second scan signal S2. In some example embodiments, one dummy pulse of the dummy off driving may be divided into a plurality of dummy pulses PS_D. A driving mode in which one dummy pulse of the dummy off driving is divided into a plurality of dummy pulses PS_D may be called split dummy off driving. Intervals WDD between the dummy pulses PS_D of the second scan signal S2 may be less than an interval WAD between the active pulse PS_A and a first dummy pulse PS_D of the second scan signal S2. The widths of the dummy pulses PS_D of the second scan signal S2 may be less than the width of the active pulse PS_A of the second scan signal S2, so that a width of the dummy-off OFF_D of the light-emitting diode in the vertical blank period VBP may be less than a width of the active-off OFF_A of the light-emitting diode in the active period AP.

In some example embodiments, the widths of the dummy pulses PS_D of the second scan signal S2 may be equal to each other. In some example embodiments, the intervals WDD between the dummy pulses PS_D of the second scan signal S2 may be equal to each other.

The first scan signal S1 may include a pulse in the active period AP, and may have a deactivation level in the vertical blank period VBP.

The first power voltage ELVDD may have a constant high voltage level VLH. The second power voltage ELVSS may have a constant low voltage level VLL. The low voltage level VLL may be lower than the high voltage level VLH.

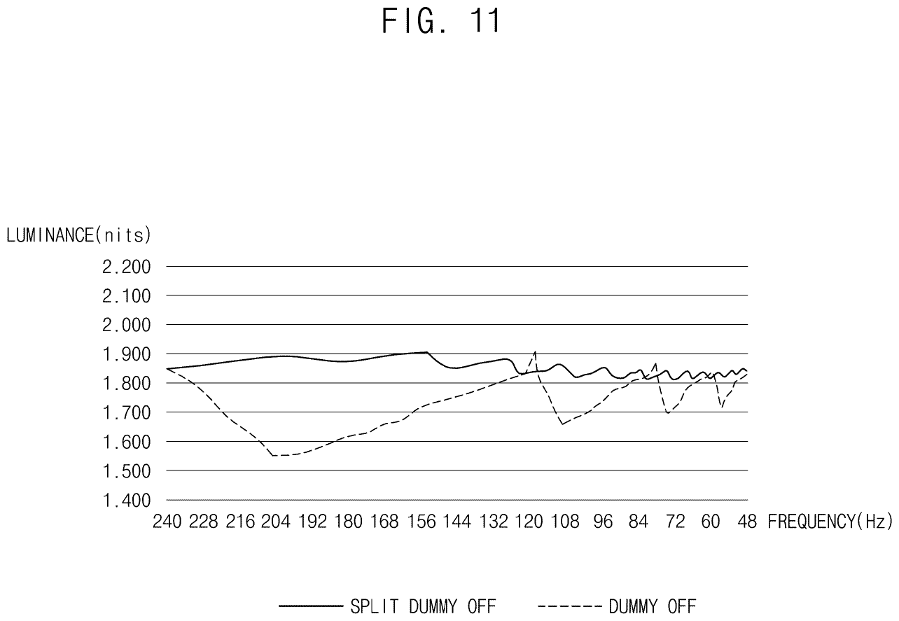

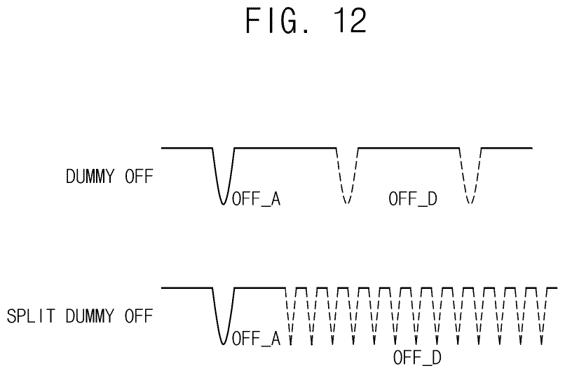

FIG. 11 is a graph illustrating a relationship between a frequency and a luminance of a display device when the dummy off driving is used and when the split dummy off driving is used. FIG. 12 is a diagram illustrating a luminance of a display device at the same frequency when the dummy off driving is used and when the split dummy off driving is used.

Referring to FIGS. 11 and 12, a luminance deviation between frequencies when the split dummy off driving is used may be less than a luminance deviation between the frequencies when the dummy off driving is used. In the dummy off driving, since the width of the dummy-off OFF_D of the light-emitting diode is relatively large, the luminance deviation between the frequencies is large depending on whether the dummy-off OFF_D of the light-emitting diode occurs. However, in the split dummy off driving, since the width of the dummy-off OFF_D of the light-emitting diode is relatively small, the luminance deviation between the frequencies may not be large regardless of whether the dummy-off OFF_D of the light-emitting diode occurs. In other words, in the dummy off driving, since the width of the dummy-off OFF_D of the light-emitting diode is relatively large, the luminance decrease is relatively large due to one dummy-off OFF_D of the light-emitting diode being added. However, in the split dummy off driving, since the width of the dummy-off OFF_D of the light-emitting diode is relatively small, the luminance decrease may not be relatively large even though one dummy-off OFF_D of the light-emitting diode is added.

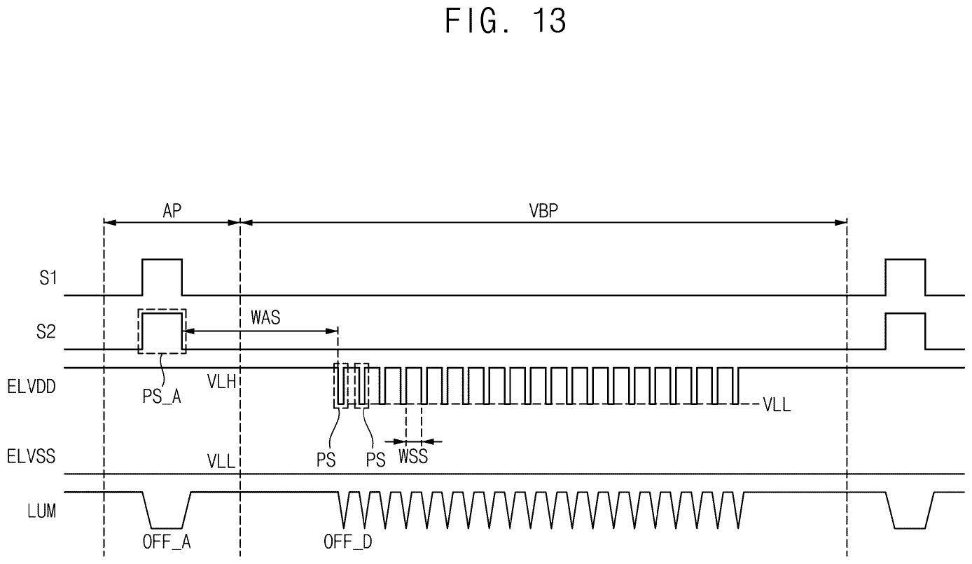

FIG. 13 is a timing diagram illustrating a first scan signal S1, a second scan signal S2, a first power voltage ELVDD, a second power voltage ELVSS, and a luminance LUM according to some example embodiments.

Referring to FIG. 13, the first power voltage ELVDD may have a constant high voltage level VLH in the active period AP, and may include a plurality of pulses PS in the vertical blank period VBP. The pulses PS of the first power voltage ELVDD may have a low voltage level VLL. The low voltage level VLL may be lower than the high voltage level VLH. In the vertical blank period VBP, a light-emitting diode of a pixel may be turned off in response to the pulses PS of the first power voltage ELVDD, and the number of off-times of the light-emitting diode in the vertical blank period VBP may be equal to the number of pulses PS of the first power voltage ELVDD in the vertical blank period VBP.

In some example embodiments, in order to reduce a luminance deviation between frequencies, widths of the pulses PS of the first power voltage ELVDD may be less than the width of the active pulse PS_A of the second scan signal S2. Further, intervals WSS between the pulses PS of the first power voltage ELVDD may be less than an interval WAS between the active pulse PS_A of the second scan signal S2 and a first pulse PS of the first power voltage ELVDD. The widths of the pulses PS of the first power voltage ELVDD are less than the width of the active pulse PS_A of the second scan signal S2, so that a width of the dummy-off OFF_D of the light-emitting diode in the vertical blank period VBP may be less than a width of the active-off OFF_A of the light-emitting diode in the active period AP.

Therefore, according to some example embodiments, a display device 100 using the split dummy off driving according to example embodiments may display an image having an improved image quality with reduced or eliminated flickering and a reduced luminance deviation.

In some example embodiments, the widths of the pulses PS of the first power voltage ELVDD may be equal to each other. In some example embodiments, the intervals WSS between the pulses PS of the first power voltage ELVDD may be equal to each other.

The first scan signal S1 may include a pulse in the active period AP, and may have a deactivation level in the vertical blank period VBP.

The second scan signal S2 may include an active pulse PS_A in the active period AP, and may have a deactivation level in the vertical blank period VBP.

The second power voltage ELVSS may have a constant low voltage level VLL.

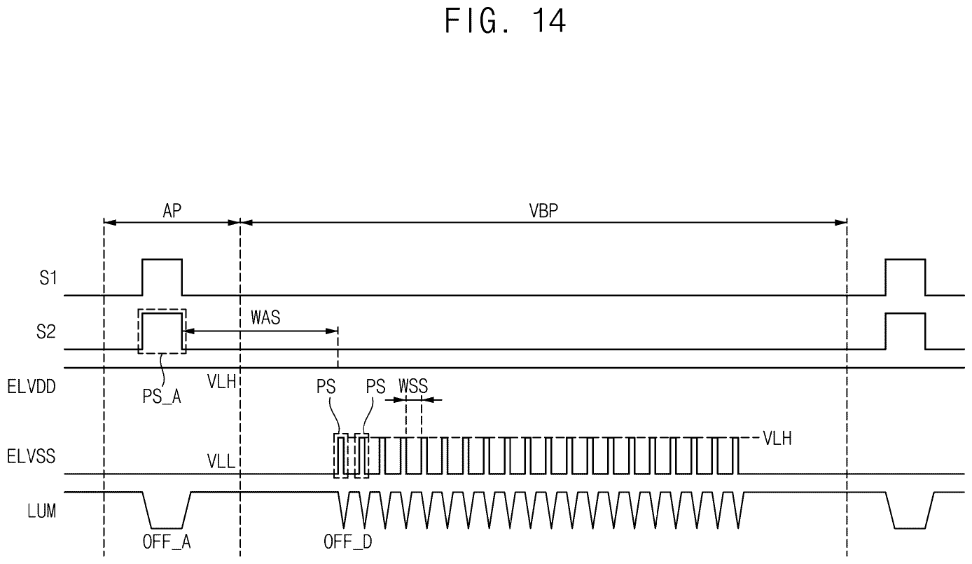

FIG. 14 is a timing diagram illustrating a first scan signal S1, a second scan signal S2, a first power voltage ELVDD, a second power voltage ELVSS, and a luminance LUM according to some example embodiments.

Referring to FIG. 14, the second power voltage ELVSS may have a constant low voltage level VLL in the active period AP, and may include a plurality of pulses PS in the vertical blank period VBP. The pulses PS of the second power voltage ELVSS may have a high voltage level VLH. The high voltage level VLH may be higher than the low voltage level VLL. In the vertical blank period VBP, a light-emitting diode of a pixel may be turned off in response to the pulses PS of the second power voltage ELVSS, and the number of off-times of the light-emitting diode in the vertical blank period VBP may be equal to the number of pulses PS of the second power voltage ELVSS in the vertical blank period VBP.

In some example embodiments, in order to reduce a luminance deviation between frequencies, widths of the pulses PS of the second power voltage ELVSS may be less than the width of the active pulse PS_A of the second scan signal S2. Intervals WSS between the pulses PS of the second power voltage ELVSS may be less than an interval WAS between the active pulse PS_A of the second scan signal S2 and the first pulse PS of the second power voltage ELVSS. The widths of the pulses PS of the second power voltage ELVSS may be less than the width of the active pulse PS_A of the second scan signal S2, so that a width of the dummy-off OFF_D of the light-emitting diode in the vertical blank period VBP may be less than a width of the active-off OFF_A of the light-emitting diode in the active period AP.

In some example embodiments, the widths of the pulses PS of the second power voltage ELVSS may be equal to each other. Some example embodiments, the intervals WSS between the pulses PS of the second power voltage ELVSS may be equal to each other.

The first scan signal S1 may include a pulse in the active period AP, and may have a deactivation level in the vertical blank period VBP.

The second scan signal S2 may include an active pulse PS_A in the active period AP, and may have a deactivation level in the vertical blank period VBP.

The first power voltage ELVDD may have a constant high voltage level VLH.

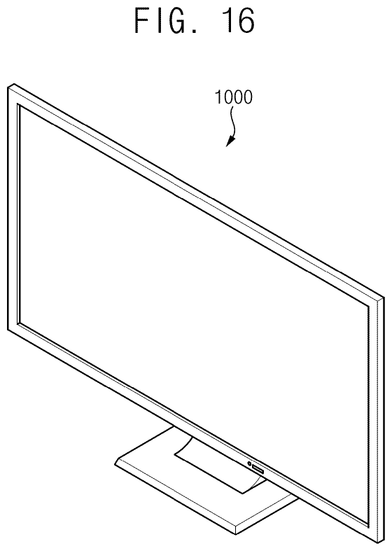

FIG. 15 is a block diagram illustrating an electronic apparatus 1000 according to some example embodiments. FIG. 16 is a diagram illustrating an example in which the electronic apparatus 1000 of FIG. 15 is implemented as a computer monitor.

Referring to FIGS. 15 and 16, the electronic apparatus 1000 may output various information through a display module 1040 within an operating system. When a processor 1010 executes an application stored in a memory 1020, the display module 1040 may provide application information to a user through a display panel 1041. In some example embodiments, the processor 1010 may provide the input image data IDAT of FIG. 1 and the control signal CTRL of FIG. 1 to the display module 1040.

The processor 1010 may obtain an external input through an input module 1030 and/or a sensor module 1061, and may execute an application corresponding to the external input. For example, when the user selects a camera icon displayed on the display panel 1041, the processor 1010 may obtain a user input through an input sensor 1061-2, and may activate a camera module 1071. The processor 1010 may transmit image data corresponding to a captured image acquired through the camera module 1071 to the display module 1040. The display module 1040 may display an image corresponding to the captured image through the display panel 1041. Some of components of the electronic apparatus 1000 may be integrated and provided as one component, or one component may be provided separately into two or more components.

The electronic apparatus 1000 may communicate with an external electronic apparatus 1002 through a network (e.g., a short-range wireless communication network or a long-range wireless communication network). In some example embodiments, the electronic apparatus 1000 may include the processor 1010, the memory 1020, the input module 1030, the display module 1040, a power module 1050, an internal module 1060, and/or an external module 1070. In some example embodiments, the electronic apparatus 1000 may omit at least one of the above-described components, and/or one or more other components may be added. In some example embodiments, some of the above-described components (e.g., a sensor module 1061, an antenna module 1062, and/or a sound output module 1063) may be integrated into another component (e.g., the display module 1040).

The processor 1010 may execute software to control at least one other component (e.g., hardware or software component) of the electronic apparatus 1000 connected to the processor 1010, and may perform various data processing and/or calculation. In some example embodiments, as at least part of data processing and/or calculation, the processor 1010 may store commands and/or data received from another component (e.g., the input module 1030, the sensor module 1061, and/or a communication module 1073) in a volatile memory 1021, may process the commands and/or data stored in the volatile memory 1021, and may store resultant data in a non-volatile memory 1022.

The processor 1010 may include a main processor 1011 and/or a coprocessor 1012. The main processor 1011 may include one or more of a central processing unit (CPU) 1011-1 and/or an application processor (AP). The main processor 1011 may further include one or more of a graphics processing unit (GPU) 1011-2, a communication processor (CP), and/or an image signal processor (ISP). At least two of the above-described processing unit and processor may be implemented as an integrated component (e.g., a single chip), or each may be implemented as an independent component (e.g., a plurality of chips).

The coprocessor 1012 may include a controller 1012-1. The controller 1012-1 may include an interface conversion circuit and/or a timing control circuit. The controller 1012-1 may receive an image signal from the main processor 1011, may convert data format of the image signal to suit the interface specifications with the display module 1040, and may output image data. The controller 1012-1 may output various control signals necessary or sufficient for driving the display module 1040.

The coprocessor 1012 may further include a data conversion circuit 1012-2, a gamma correction circuit 1012-3, a rendering circuit 1012-4, etc. The data conversion circuit 1012-2 may receive the image data from the controller 1012-1, and may compensate the image data such that the image is displayed at a desired luminance according to the characteristics of the electronic apparatus 1000 and/or the user's settings or may convert the image data to reduce power consumption and/or compensate for afterimages. The gamma correction circuit 1012-3 may convert the image data and/or a gamma reference voltage such that an image displayed on the electronic apparatus 1000 has desired gamma characteristics. The rendering circuit 1012-4 may receive the image data from the controller 1012-1, and may render the image data by considering a pixel arrangement of the display panel 1041 applied to the electronic apparatus 1000. At least one of the data conversion circuit 1012-2, the gamma correction circuit 1012-3, and/or the rendering circuit 1012-4 may be integrated into another component (e.g., the main processor 1011 and/or a controller). At least one of the data conversion circuit 1012-2, the gamma correction circuit 1012-3, and/or the rendering circuit 1012-4 may be integrated into a data driver 1043 to be described below.

The memory 1020 may store various data used by at least one component of the electronic apparatus 1000 (e.g., the processor 1010 and/or the sensor module 1061) and input data and/or output data for commands related thereto. The memory 1020 may include at least one of the volatile memory 1021 and/or the non-volatile memory 1022.

The input module 1030 may receive commands and/or data to be used in components of the electronic apparatus 1000 (e.g., the processor 1010, the sensor module 1061, and/or the sound output module 1063) from the outside of the electronic apparatus 1000 (e.g., the user and/or the external electronic apparatus 1002).

The input module 1030 may include a first input module 1031 through which commands and/or data are input from the user, and/or a second input module 1032 through which commands and/or data are input from the external electronic apparatus 1002. The first input module 1031 may include a microphone, a mouse, a keyboard, a key (e.g., button), and/or a pen (e.g., passive pen and/or active pen). The second input module 1032 may support a designated protocol that may connect to the external electronic apparatus 1002 by wire and/or wirelessly. In some example embodiments, the second input module 1032 may include a high definition multimedia interface (HDMI), a universal serial bus (USB) interface, an SD card interface, and/or an audio interface. The second input module 1032 may include a connector that may be physically connected to the external electronic apparatus 1002, for example, an HDMI connector, a USB connector, an SD card connector, and/or an audio connector (e.g., a headphone connector).

The display module 1040 may provide visual information to the user. The display module 1040 may include the display panel 1041, a gate driver 1042, and/or the data driver 1043. The display module 1040 may further include a window, a chassis, and/or a bracket to protect the display panel 1041. The display module 1040 may correspond to the display device 100 of FIG. 1. The display panel 1041, the gate driver 1042, and the data driver 1043 may correspond to the display panel 110, the scan driver 130, and the data driver 120 of FIG. 1, respectively.

The power module 1050 may supply power to components of the electronic apparatus 1000. The power module 1050 may include a battery that charges power voltage. The battery may include a non-rechargeable primary cell, a rechargeable secondary cell, and/or a fuel cell. The power module 1050 may include a power management circuit 1051. The power management circuit 1051 may supply optimized power to each, or one or more, of the above-described modules and/or the modules described below. The power management circuit 1051 may correspond to the power management circuit 140 of FIG. 1. The power module 1050 may include a wireless power transmission/reception member electrically connected to the battery. The wireless power transmission/reception member may include a plurality of coil-shaped antenna radiators.

The electronic apparatus 1000 may further include the internal module 1060 and/or the external module 1070. The internal module 1060 may include the sensor module 1061, the antenna module 1062, and/or the sound output module 1063. The external module 1070 may include the camera module 1071, a light module 1072, and/or a communication module 1073.

The sensor module 1061 may detect an input by the user's body and/or an input by the pen among the first input module 1031, and may generate an electrical signal and/or a data value corresponding to the input. The sensor module 1061 may include at least one of a fingerprint sensor 1061-1, an input sensor 1061-2, and/or a digitizer 1061-3.

The processor 1010 may output commands and/or data to the display module 1040, the sound output module 1063, the camera module 1071, and/or the light module 1072 based on the input data received from the input module 1030. For example, the processor 1010 may generate image data in response to input data applied through the mouse and/or the active pen and output the image data to the display module 1040, or may generate command data in response to the input data to output the command data to the camera module 1071 and/or the light module 1072. When no input data is received from the input module 1030 for a certain period of time, the processor 1010 may switch an operation mode of the electronic apparatus 1000 to a low-power mode and/or a sleep mode to reduce power consumption of the electronic apparatus 1000.

The processor 1010 may output commands and/or data to the display module 1040, the sound output module 1063, the camera module 1071, and/or the light module 1072 based on sensing data received from the sensor module 1061. For example, the processor 1010 may compare authentication data authorized by the fingerprint sensor 1061-1 with authentication data stored in the memory 1020, and then may execute an application according to the comparison result. The processor 1010 may execute command and/or output corresponding image data to the display module 1040 based on sensing data detected by the input sensor 1061-2 or the digitizer 1061-3. When the sensor module 1061 includes a temperature sensor, the processor 1010 may receive temperature data for a temperature measured from the sensor module 1061, and may further perform luminance correction for the image data or the like based on the temperature data.

In some example embodiments, as illustrated in FIG. 16, the electronic apparatus 1000 may be implemented as a computer monitor. However, example embodiments are not limited thereto, and in some example embodiments, the electronic apparatus 1000 may be implemented as a television, a mobile phone, a video phone, a smart pad, a smart watch, a tablet PC, a vehicle navigation, a laptop, a head mounted display device, an artificial reality (AR) apparatus, etc.

The display device according to some example embodiments may be applied to a display device included in a computer, a notebook, a mobile phone, a smart phone, a smart pad, a smart watch, a PMP, a PDA, an MP3 player, and/or the like.

One or more of the elements disclosed above may include or be implemented in one or more processing circuitries such as hardware including logic circuits; a hardware/software combination such as a processor executing software; or a combination thereof. For example, the processing circuitries more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Although the display device and the electronic apparatus according to some example embodiments have been described with reference to the drawings, the illustrated embodiments are examples, and may be modified and changed by a person having ordinary knowledge in the relevant technical field without departing from the technical spirit described in the following claims.

What is claimed is:

1. A display device comprising:
a display panel including a pixel;
a scan driver configured to provide a first scan signal and a second scan signal to the pixel; and
a power management circuit configured to provide a first power voltage and a second power voltage to the pixel,
wherein the second scan signal includes an active pulse in an active period having a constant time length and a plurality of dummy pulses in a vertical blank period having a variable time length,
wherein widths of the plurality of dummy pulses are less than a width of the active pulse, and
wherein intervals between the plurality of dummy pulses are less than an interval between the active pulse and a first dummy pulse of the plurality of dummy pulses.

2. The display device of claim 1, wherein the widths of the plurality of dummy pulses are equal to each other.

3. The display device of claim 1, wherein the intervals between the plurality of dummy pulses are equal to each other.

4. The display device of claim 1, wherein the pixel includes:
a first transistor including a first gate connected to a first node, a first terminal configured to receive the first power voltage, and a second terminal connected to a second node;
a second transistor including a second gate configured to receive the first scan signal, a third terminal configured to receive a data voltage, and a fourth terminal connected to the first node;
a third transistor including a third gate configured to receive the second scan signal, a fifth terminal configured to receive a reference voltage, and a sixth terminal connected to the second node;
a capacitor including a seventh terminal connected to the first node and an eighth terminal connected to the second node; and
a light-emitting diode including a ninth terminal connected to the second node and a tenth terminal configured to receive the second power voltage.

5. The display device of claim 4, wherein the capacitor is configured to store a difference between the data voltage and the reference voltage in response to a pulse of the first scan signal and the active pulse of the second scan signal in the active period, and
wherein the third transistor is configured to apply the reference voltage to the second node in response to the plurality of dummy pulses.

6. The display device of claim 5, wherein a voltage level of the reference voltage is lower than a voltage level of a threshold voltage of the light-emitting diode.

7. The display device of claim 4, wherein the first scan signal includes a pulse in the active period, and a deactivation level in the vertical blank period.

8. The display device of claim 4, wherein
the first power voltage has a constant high voltage level, and
the second power voltage has a constant low voltage level lower than the constant high voltage level.

9. A display device comprising:
a display panel including a pixel;
a scan driver configured to provide a first scan signal and a second scan signal to the pixel; and
a power management circuit configured to provide a power voltage to the pixel,
wherein the second scan signal includes an active pulse in an active period having a constant time length,
wherein the power voltage includes a plurality of pulses in a vertical blank period having a variable time length,
wherein widths of the plurality of pulses of the power voltage are less than a width of the active pulse, and
wherein intervals between the plurality of pulses of the power voltage are less than an interval between the active pulse and a first pulse of the plurality of pulses of the power voltage.

10. The display device of claim 9, wherein the widths of the plurality of pulses of the power voltage are equal to each other.

11. The display device of claim 9, wherein the intervals between the plurality of pulses of the power voltage are equal to each other.

12. The display device of claim 9, wherein the pixel includes:
a first transistor including a gate connected to a first node, a first terminal configured to receive a first power voltage, and a second terminal connected to a second node;
a second transistor including a second gate configured to receive the first scan signal, a third terminal configured to receive a data voltage, and a fourth terminal connected to the first node;
a third transistor including a gate configured to receive the second scan signal, a fifth terminal configured to receive a reference voltage, and a sixth terminal connected to the second node;
a capacitor including a seventh terminal connected to the first node and an eighth terminal connected to the second node; and
a light-emitting diode including a ninth terminal connected to the second node and a tenth terminal configured to receive a second power voltage,
wherein the power voltage is the first power voltage or the second power voltage.

13. The display device of claim 12, wherein
the power voltage is the first power voltage, and has a constant high voltage level in the active period, and
the plurality of pulses of the power voltage have a low voltage level lower than the constant high voltage level.

14. The display device of claim 12, wherein
the power voltage is the second power voltage, and has a constant low voltage level in the active period, and
the plurality of pulses of the power voltage have a high voltage level higher than the constant low voltage level.

15. The display device of claim 12, wherein the first scan signal includes a pulse in the active period, and a deactivation level in the vertical blank period.

16. The display device of claim 12, wherein the second scan signal has a deactivation level in the vertical blank period.

17. An electronic apparatus comprising:
a display device; and
a processor configured to control the display device,
wherein the display device comprises,
a display panel including a pixel;
a scan driver configured to provide a first scan signal and a second scan signal to the pixel; and
a power management circuit configured to provide a first power voltage and a second power voltage to the pixel,
wherein the second scan signal includes an active pulse in an active period having a constant time length and a plurality of dummy pulses in a vertical blank period having a variable time length,
wherein widths of the plurality of dummy pulses are less than a width of the active pulse, and
wherein intervals between the plurality of dummy pulses are less than an interval between the active pulse and a first dummy pulse of the plurality of dummy pulses.

18. The electronic apparatus of claim 17, wherein the widths of the plurality of dummy pulses are equal to each other.

19. The electronic apparatus of claim 17, wherein the intervals between the plurality of dummy pulses are equal to each other.

20. The electronic apparatus of claim 17, wherein the pixel includes:
a first transistor including a first gate connected to a first node, a first terminal configured to receive the first power voltage, and a second terminal connected to a second node;
a second transistor including a second gate configured to receive the first scan signal, a third terminal configured to receive a data voltage, and a fourth terminal connected to the first node;
a third transistor including a third gate configured to receive the second scan signal, a fifth terminal configured to receive a reference voltage, and a sixth terminal connected to the second node;
a capacitor including a seventh terminal connected to the first node and an eighth terminal connected to the second node; and
a light-emitting diode including a ninth terminal connected to the second node and a tenth terminal configured to receive the second power voltage.
